(19) United States
(12) Patent Application Publication
(10) Pub. No.: US 2009/0205055 A1
(43) Pub. Date: Aug. 13, 2009

(54) SYSTEM AND METHOD FOR ELECTRONIC LICENSE DISTRIBUTION FOR PRE-INSTALLED SOFTWARE

(76) Inventor: Andrey I. Savov, Fullerton, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/027,830

(22) Filed: Feb. 7, 2008

(51) Int. Cl. G06F 9/445; G06F 21/00

(52) U.S. Cl. 726/31; 717/168

(57) ABSTRACT

The subject application is directed to a system and method for electronic license distribution for pre-installed software. Data communication is first commenced between a data processing device and an associated portable data device. License data is then communicated between the portable data device and the data processing device, with the license data corresponding to a software license associated with the previously installed software resident in a data storage associated with the data processing device. The previously installed software is then activated in accordance with the communicated license data.

### BACKGROUND OF THE INVENTION

The subject application is directed generally to activation of software, and is particularly useful in activating previously installed copies of software in multiple devices.

Modern data processing devices typically incorporate an intelligent subsystem. Such subsystems include a hardware platform inclusive of a processor and data storage. By way of example, many devices will incorporate a computer, such as is the case with an intelligent controller, which forms a part of office machines. Such office machines include copiers, facsimile machines, scanners, printers, plotters, electronic mail devices, or multifunction peripherals having more than one of these capabilities. In addition to a hardware platform, devices include a software platform. Software typically includes an underlying operating system, application level software, and device drivers.

Software, such as that noted above, is frequently subjected to distribution or operative control by employment of licensing schemes. Licensing can be contractual only, wherein legal rights are relied upon to prevent unauthorized use or distribution. Given difficulties in monitoring or enforcing copying or use of easily copied or transported software, many vendors will augment legally defined rights with technology-based control mechanisms.

Technological control of software distribution is suitably accomplished with key distribution. Currently, key-based schemes exist in hardware and in software. A hardware key is typically associated with a port on a data processing device, such as with a “dongle.” Software operation is constrained unless a hardware key is present, therefore limiting operation of copies of software in accordance with a number of corresponding hardware components.

Software-based copy protection schemes may employ unique activation codes. Software that is installed on systems is not available for use until such time as it is activated with an appropriate code. Typical codes that are used for activation are somewhat arbitrary and lengthy to minimize risk of circumvention. While activation of software on a single machine or a limited number of machines is relatively straightforward and quickly completed, the task becomes increasingly difficult when more machines require activation.

Many enterprises will replicate software installations many times. By way of example, a master software template is made and an image is made for each of many installations. It is incumbent that requisite steps be performed by an administrator to activate each such installation. In addition, updated or added software is frequently installed on machines, either by physical distribution from portable media or by pushing or pulling of software via a data communication network or link. In the above situations, many installations may be made, requiring considerable administrative time or effort in order to activate the many installations.

### SUMMARY OF THE INVENTION

In accordance with one embodiment of the subject application, there is provided a system and method for activation of software.

Further, in accordance with one embodiment of the subject application, there is provided a system and method for activating previously installed copies of software in multiple devices.

Still further, in accordance with one embodiment of the subject application, there is provided a system for electronic license distribution for pre-installed software. The system comprises a data processing device including a data storage and a processor and means adapted for commencing data communication between the data processing device and an associated portable data device. The system further includes communication means adapted for communicating license data between the portable data device and the data processing device, which license data is representative of a software license associated with software resident in a data storage associated with the data processing device. The system also includes activation means adapted for activating the resident software in accordance with communicated license data.

In one embodiment of the subject application, the portable data device includes a portable data storage adapted for storing data representative of a pre-set number of activation licenses available for multiple copies of resident software disposed in a plurality of data processing devices. In such embodiment, the system further comprises means adapted for decrementing a count value associated with the pre-set number of activation licenses upon operation of the activation means. Preferably, the count value is stored in the portable data storage.

In another embodiment of the subject application, the system further comprises means adapted for suspending activation of resident software when the count value corresponds to a use of all activation licenses associated with the pre-set number.

In a further embodiment of the subject application, the system also comprises means adapted for storing activation data in the portable data storage, which activation data includes data representative of an identifier corresponding to each of a plurality of data processing devices for which resident software has been activated by the portable data storage.

In yet another embodiment of the subject application, the communications means includes means adapted for communicating the license data in encrypted form, wherein encryption of the license data corresponds to identification data associated with the portable data device.

Still further, in accordance with one embodiment of the subject application, there is provided a method for electronic license distribution for pre-installed software in accordance with the system as set forth above.

Still other advantages, aspects and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for electronic license distribution for pre-installed software according to one embodiment of the subject application;

FIG. 2 is a block diagram illustrating controller hardware for use in the system for electronic license distribution for pre-installed software according to one embodiment of the subject application;

FIG. 3 is a functional diagram illustrating the controller for use in the system for electronic license distribution for pre-installed software according to one embodiment of the subject application;

FIG. 4 is a block diagram illustrating a server for use in the system for electronic license distribution for pre-installed software according to one embodiment of the subject application;

FIG. 5 is a flowchart illustrating a method for electronic license distribution for pre-installed software according to one embodiment of the subject application;

FIG. 6 is a flowchart illustrating a method for electronic license distribution for pre-installed software according to one embodiment of the subject application; and

FIG. 7 is a flowchart illustrating a method for electronic license distribution for pre-installed software according to one embodiment of the subject application.

### DETAILED DESCRIPTION OF THE PREFERRED EMBODIMENT

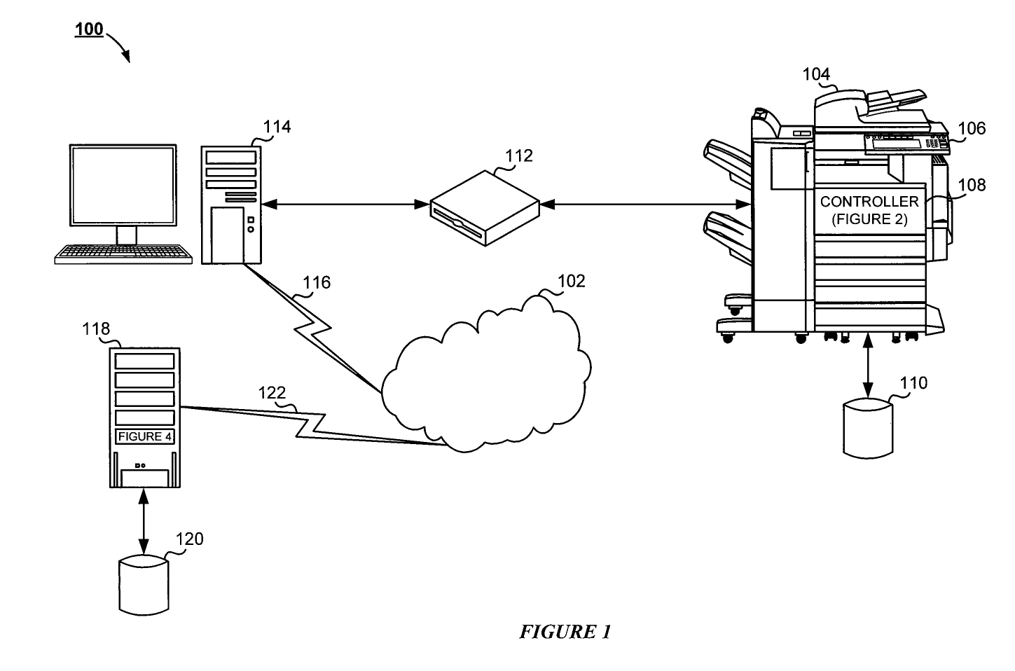

The subject application is directed to a system and method for activation of software. In particular, the subject application is directed to a system and method for activating previously installed copies of software in multiple devices. It will become apparent to those skilled in the art that the system and method described herein are suitably adapted to a plurality of varying electronic fields employing licensed software including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for electronic license distribution for pre-installed software in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

According to one embodiment of the subject application, the document processing device 104 is suitably equipped to receive a plurality of portable data devices 112 including, without limitation, Firewire drive, USB drive, SD, MMC, XD, Compact Flash, Memory Stick, and the like. The portable data device 112, as will be understood by those skilled in the art, includes any non-volatile memory, such as flash memory, magnetic storage, optical storage, and the like. Preferably, the portable data device 112 is capable of storing encrypted or unencrypted data corresponding to license activation codes, document processing device identification data, administrative data, or the like. The functioning of the portable data device 112 is explained in greater detail below.

In accordance with one particular embodiment of the subject application, the document processing device 104 further includes an associated user interface 106 such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, receive input from the associated user, and communicate the same to a backend component, such as a controller 108, as explained in greater detail below.

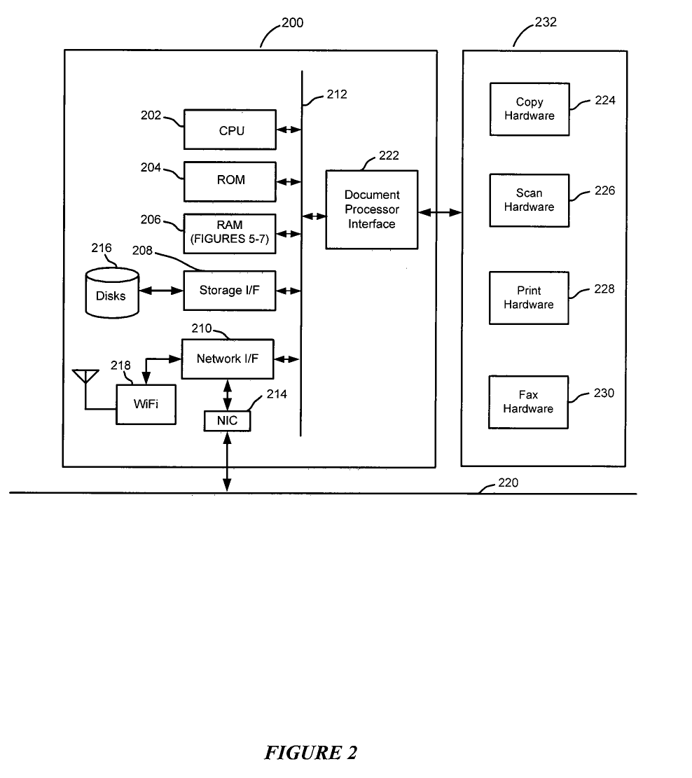

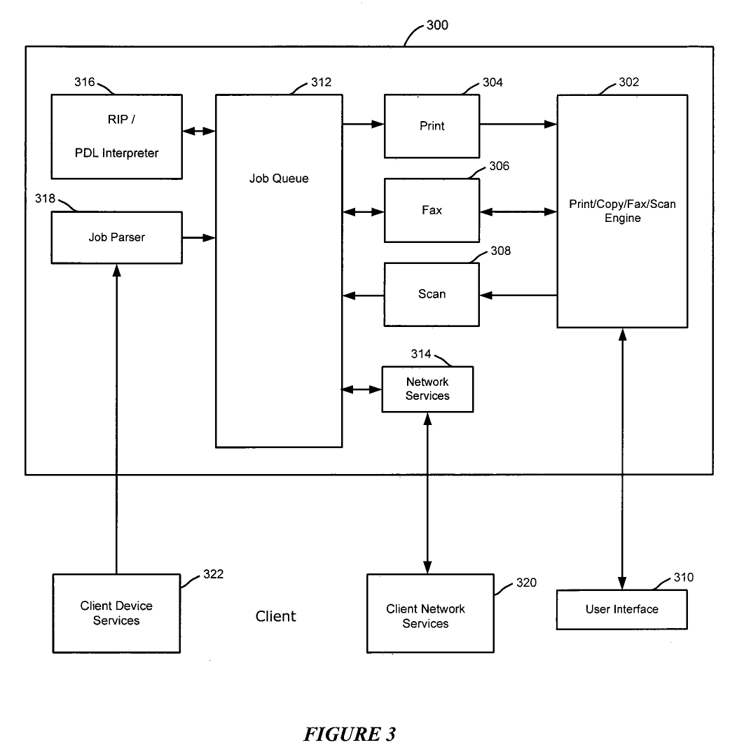

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any of the myriad components associated with the document processing device 104, including hardware, software, or combinations thereof, that function to perform, cause to be performed, control, or otherwise direct the methodologies described hereinafter. It will be understood by those skilled in the art that the methodologies described with respect to the controller 108 are capable of being performed by any general purpose computing system known in the art and, thus, the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for electronic license distribution for pre-installed software of the subject application. The functioning of the controller 108 will be better understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like.

According to the preferred embodiment of the subject application, the document processing device 104 is a stand-alone device. That is, the document processing device 104 is not in data communication with the computer network 102. It will be appreciated by those skilled in the art, however, that, while depicted in FIG. 1 as a stand-alone device, the document processing device 104 is capable of being connected to the computer network 102 via a suitable communications link (not shown) such as, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

The system 100 illustrated in FIG. 1 further depicts a user device 114 in data communication with the computer network 102 via a communications link 116. It will be appreciated by those skilled in the art that the user device 114 is shown in FIG. 1 as a computer workstation for illustration purposes only. As will be understood by those skilled in the art, the user device 114 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. In accordance with one embodiment of the subject application, the user device 114 is capable of interacting with the portable data device 112 and transferring data to the portable data device 112 such as, for example and without limitation, license data received from a license server 118, as explained in greater detail below.

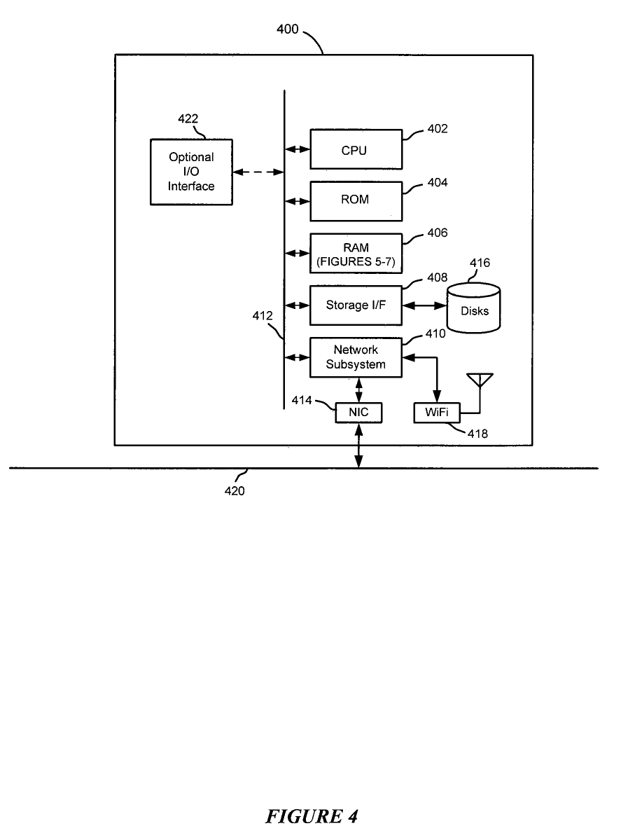

The system 100 of FIG. 1 also includes a license server 118, communicatively coupled to the computer network 102 via a communications link 122. It will be appreciated by those skilled in the art that the server 118 comprises hardware, software, and combinations thereof suitably adapted to provide one or more services, web-base applications, storage options, and the like, to networked devices. In accordance with one embodiment of the subject application, the server 118 includes various components implemented as hardware, software, or a combination thereof for managing the performance of web services processes accessed via the computer network 102. The communications link 122 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components for updating document processing device 104 software described with respect to the server 118 hereinafter are capable of implementation on any computing device coupled to the computer network 102 and functioning as a server side of a client/server relationship. Preferably, any such license data, update data, or the like is capable of being transferred to the user device 114 via the computer network 102 for transfer to the portable data device 112, directly transferred to the portable data device 112, or the like. The functioning of the server 118 will better be understood in conjunction with the block diagrams illustrated in FIG. 4, explained in greater detail below.

Communicatively coupled to the server 118 is a data storage device 120. In accordance with the preferred embodiment of the subject application, the data storage device 120 is any mass storage device known in the art including, for example and without limitation, magnetic storage drives, a hard disk drive, optical storage devices, flash memory devices, or any suitable combination thereof. In the preferred embodiment, the data storage device 120 is suitably adapted to store software updates, software license data, document processing device identification data, update lists, electronic database data, document data, image data, or the like. It will be appreciated by those skilled in the art that, while illustrated in FIG. 1 as being a separate component of the system 100, the data storage device 120 is capable of being implemented as an internal storage component of the license server 118 or the like such as, for example and without limitation, an internal hard disk drive or the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device known in the art that is capable of facilitating the methodologies described herein. Included is a processor 202, suitably comprised of a central processor unit. However, processor 202 may advantageously be composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the controller 200.

Also included in the controller 200 is random access memory 206 suitably formed of dynamic random access memory, static random access memory, or any other suitable addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the controller 200. By way of example, illustrated is at least one network interface card 214 for data communication with fixed or wired networks such as Ethernet, token ring, and the like and a wireless interface 218 suitably adapted for wireless communication via means such as WiFi, WiMax, wireless modem, cellular network, or any suitable wireless communication system. It is to be appreciated, however, that the network interface subsystem suitably utilizes any physical or non-physical data transfer layer or protocol layer, as will be appreciated by one of ordinary skill in the art. In the illustration, the network interface 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device such as the document processing device 104, which includes the controller 200 of FIG. 2 (shown in FIG. 1 as the controller 108) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality, as will be appreciated by one of ordinary skill in the art.

In the preferred embodiment, the engine 302 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices capable of performing one or more of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms such as bit map, page description language or vector format, and the like are suitably relayed from the scan function 308 for subsequent handling via the job queue 312

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter, or any suitable mechanism for interchange of an electronic document to a format better suited for interchange with device functions such as print 304, facsimile 306, or scan 308.

Finally, the job queue 312 is in data communication with a parser 318, which parser 318 suitably functions to receive print job language files from an external device such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a representative architecture of a suitable server 400, depicted in FIG. 1 as the license server 118, on which operations of the subject system are completed. Included is a processor 402 suitably comprised of a central processor unit. However, processor 402 may advantageously be composed of multiple processors working in concert with one another, as will be appreciated by one of ordinary skill in the art. Also included is a non-volatile or read only memory 404, which is advantageously used for static or fixed data or instructions such as BIOS functions, system functions, system configuration, and other routines or data used for operation of the server 400.

Also included in the server 400 is random access memory 406 suitably formed of dynamic random access memory, static random access memory, or any other suitable addressable memory system. Random access memory 406 provides a storage area for data instructions associated with applications and data handling accomplished by the processor 402.

A storage interface 408 suitably provides a mechanism for volatile, bulk or long term storage of data associated with the server 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the server 400 to communicate to other devices. The network interface subsystem 410 suitably interfaces with one or more connections with external devices to the server 400. By way of example, illustrated is at least one network interface card 414 for data communication with fixed or wired networks such as Ethernet, token ring, and the like and a wireless interface 418 suitably adapted for wireless communication via means such as WiFi, WiMax, wireless modem, cellular network, or any suitable wireless communication system. It is to be appreciated, however, that the network interface subsystem suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network subsystem 410 is suitably accomplished via a bus data transfer mechanism, such as illustrated by bus 412.

Suitable executable instructions on the server 400 facilitate communication with a plurality of external devices such as workstations, document processing devices, other servers, or the like. While in operation a typical server operates autonomously, it is to be appreciated that direct control by a local user is sometimes desirable and is suitably accomplished via an optional input/output interface 422, as will be appreciated by one of ordinary skill in the art.

In operation, data communication is first commenced between a data processing device and an associated portable data device. License data is then communicated between the portable data device and the data processing device. The license data corresponds to a software license associated with previously installed software resident in a data storage associated with the data processing device. The previously installed software is then activated in accordance with the communicated license data.

According to one example embodiment of the subject application, a portable data device 112 is first detected by the user device 114 for use as a medium for transporting license activation data amongst a plurality of data processing devices, represented in FIG. 1 as the document processing device 104. It will be appreciated by those skilled in the art that suitable portable data devices include, for example and without limitation, flash-based memory devices such as xD, SD, smart media, compact flash, memory stick, etc.; optical storage such as CD, DVD; magnetic storage devices, e.g., portable hard disk drives; universal serial bus drives; or the like. The user device 114, via interaction with a suitable user, e.g., an administrator, distributor, or the like, then communicates with the license server 118 via the computer network 102. Preferably, the communications between the license server 118 (communications link 122) and the user device 114 (communications link 116) are facilitated via secure means, e.g., encryption, SSL, or the like. The server 118 then retrieves from the data storage device 120 license data corresponding to activation licenses for the activation of software previously installed on one or more data processing devices, e.g., the document processing device 104. The license data is then communicated to the user device 114 from the server 118 via secure communications channels as set forth above.

The license data is then received by the user device 114 along with data corresponding to a pre-set number of activation licenses. Preferably, this pre-set number of activation licenses suitably corresponds to a pre-set number of previously installed copies of selected software. That is, the pre-set number of activation licenses corresponds to a number of data processing devices upon which software requiring such licenses has been previously installed. For example, when the user device 114 corresponds to a distributor, the pre-set number of activation licenses corresponds to the number of data processing devices shipped to the distributor by a manufacturer, as represented by the license server 118. In addition, identifier data corresponding to each data processing device for which an activation license is associated is then received by the user device 114. It will be appreciated by those skilled in the art that suitable identifier data includes, for example and without limitation, a serial number associated with each data processing device, a MAC identifier associated with each device, or any other such identifier corresponding to the data processing devices. The received data is then stored on the portable data device 112 for further operations in accordance with this example embodiment of the subject application.

In accordance with such an example embodiment, software is first installed on a data processing device such as the document processing device 104 corresponding to software requiring a license for use thereon. Preferably, the software is installed, for example, by a manufacturer or distributor prior to shipment to an end user such as in an office environment. The software is suitably resident in the data storage device 110 in data communication with the document processing device 104; however, such software is preferably inactive until such time as a suitable license is acquired. A determination is then made as to whether the software is installed with an activation license. When the controller 108 or other suitable component associated with the document processing device 104 determines that the resident software already has a license associated therewith, the software is activated and enabled on the document processing device 104.

When no activation license is determined to be present, the software remains inactive, i.e., unavailable for use by the document processing device 104. Upon the detection of a portable data device 112 by the controller 108 or other suitable component associated with the document processing device 104, the portable data device 112 is accessed to determine whether activation license data is present. It will be appreciated by those skilled in the art that the portable data device 112 is representative of any non-volatile data storage device known in the art including, for example and without limitation, universal serial bus drives, flash memory, e.g., xD, SD, Compact Flash, memory stick, smart media, or the like, optical disk, magnetic storage, or the like. For example, upon the insertion of a suitable portable data device 112 by an administrator, distributor, or the like, the portable data device 112 is analyzed to determine whether license activation data is present corresponding to pre-installed software. When activation license data is not present, the software remains unavailable for use.

Upon a determination that software license activation data is present on the portable data device 112, identifier data corresponding to the document processing device 104 is then compared to identifier data present on the accessed portable data device 112. For example, the serial number associated with the document processing device 104 is compared to those serial numbers on the portable data device 112 to determine whether the document processing device 104 has license activation data associated therewith. When the identifiers do not match, the document processing device 104 is denied the ability to activate the software, which therefore remains unavailable for use by the document processing device 104. When the identifiers do match, a count value associated with the pre-set number of available licenses is analyzed to determine whether any activation licenses remain available. That is, a determination is made as to whether the pre-set number of activation licenses has been exhausted. When no license is available based upon the count value, the document processing device 104 is denied the ability to access the resident software.

Upon a determination that a license is available, pursuant to the analyzed count value, the license data is communicated to the document processing device 104 from the portable data device 112. Thereafter, the previously installed software resident on the data storage device 110 is activated and made available for use by the document processing device 104. The count value stored on the portable data device 112 is then decremented to reflect the use of the license by the document processing device 104. Thus, the skilled artisan will appreciate that the administrator, distributor, or the like is thereafter able to proceed to the next data processing device, having pre-installed software for activation in accordance with the example embodiment described above.

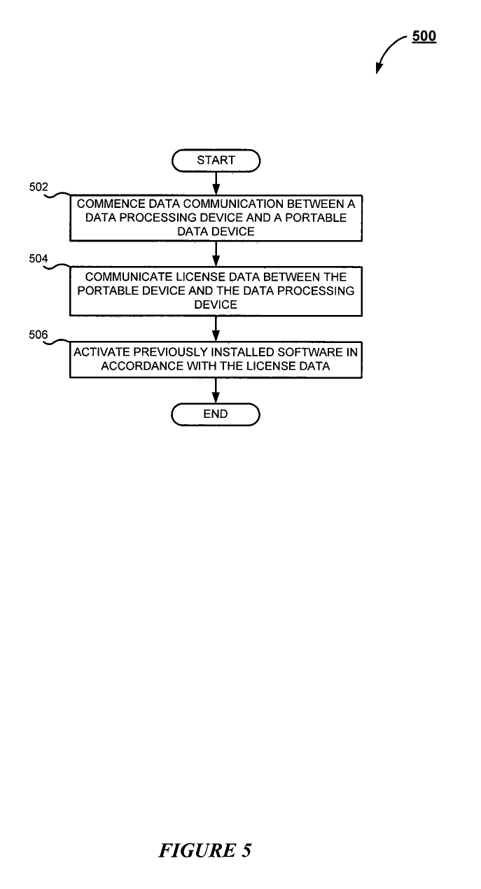

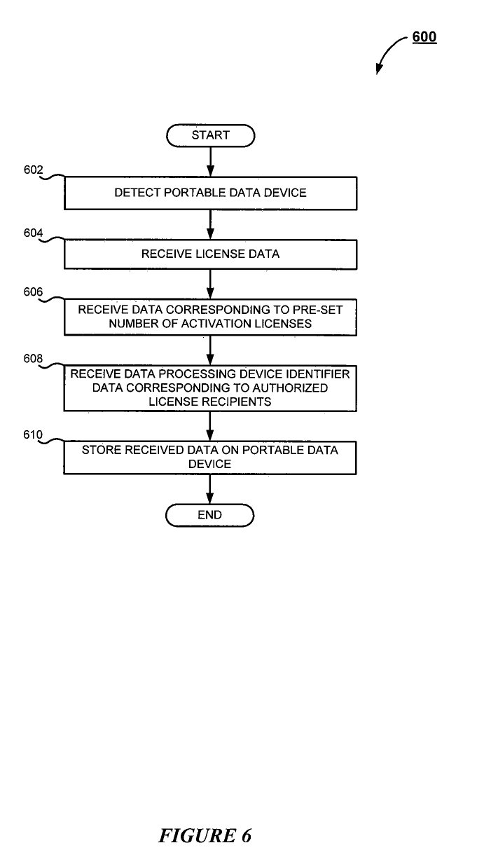

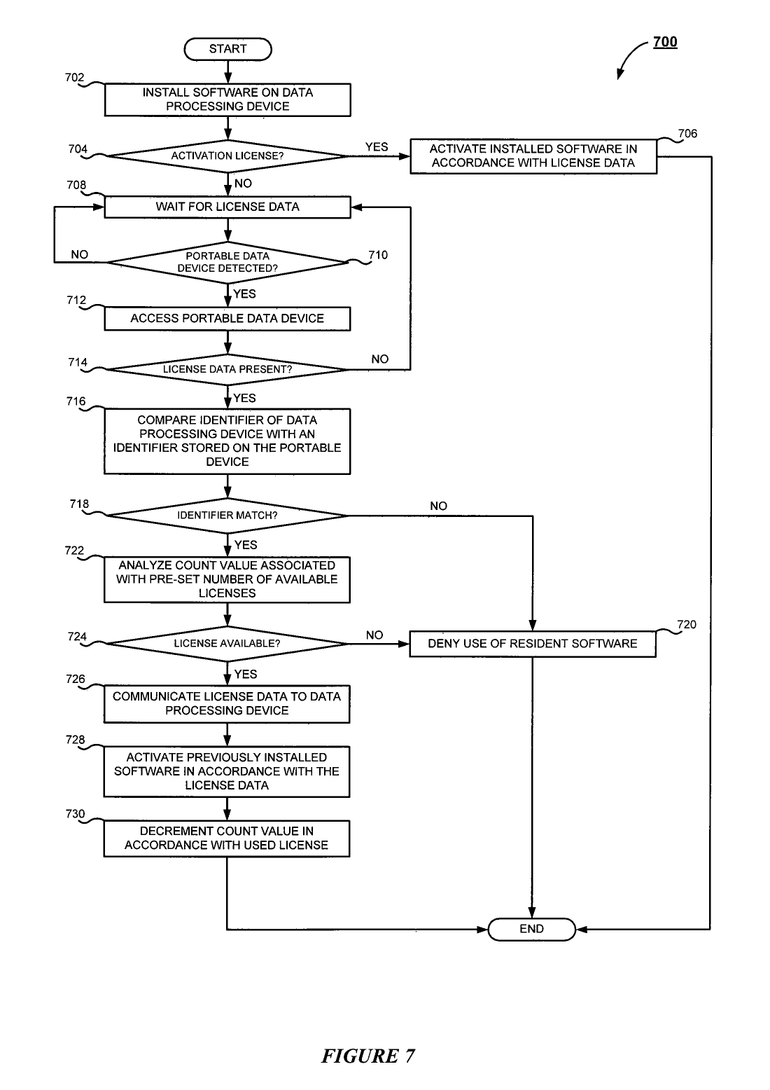

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5, FIG. 6, and FIG. 7. Turning now to FIG. 5, there is shown a flowchart 500 illustrating a method for electronic license distribution for pre-installed software in accordance with one embodiment of the subject application. Beginning at step 502, data communication is first commenced between a data processing device and an associated portable data device. For example, the portable data device 112 is inserted into an appropriate receiver associated with the document processing device 104, which has software stored on the data storage device 110. At step 504, license data is communicated between the portable data device 112 and the data processing device, e.g., the document processing device 104. In accordance with one embodiment of the subject application, the license data corresponds to a software license associated with the previously installed software resident in the data storage device 110. Thereafter, at step 506, the previously installed software resident on the data storage device 110 is activated in accordance with the license data and is thus available for use by the document processing device 104.

Referring now to FIG. 6, there is shown a flowchart 600 illustrating a method for electronic license distribution for pre-installed software in accordance with one embodiment of the subject application. The methodology illustrated in FIG. 6 begins at step 602, whereupon the portable data device 112 is first detected by the user device 114. In accordance with such an embodiment, the portable data device 112 is capable of use as a medium for transporting license activation data amongst a plurality of data processing devices, depicted in FIG. 1 as the document processing device 104. It will be appreciated by those skilled in the art that suitable portable data devices include, for example and without limitation, flash-based memory devices such as xD, SD, smart media, compact flash, memory stick, etc.; optical storage, such as CD, DVD; magnetic storage devices, e.g., portable hard disk drives; universal serial bus drives; or the like.

At step 604, license data is received from the license server 118 via the computer network 102. It will be appreciated by those skilled in the art that the user device 114, via interaction with a suitable administrator, distributor, or other such user, communicates with the license server 118 via the computer network 102 using secure communications channels including, for example and without limitation, encryption, SSL, or the like. During such communications, the server 118 retrieves license data from the data storage device 120 corresponding to activation licenses for the activation of software previously installed on one or more data processing devices, e.g., the document processing device 104. The license data is then communicated to the user device 114 from the server 118 via secure communications channels as set forth above.

Data corresponding to a pre-set number of activation licenses is then received by the user device 114 at step 606. It will be understood by those skilled in the art that the pre-set number of activation licenses represents a pre-set number of previously installed copies of selected software, e.g., software requiring licenses for activation that is installed in a corresponding number of data processing devices. For example, when the user device 114 corresponds to a distributor, the pre-set number of activation licenses corresponds to the number of data processing devices shipped to the distributor by a manufacturer, as represented by the license server 118.

At step 608, the user device 114 receives identifier data corresponding to each data processing device for which an activation license is associated. It will be appreciated by those skilled in the art that suitable identifier data includes, for example and without limitation, a serial number associated with each data processing device, a MAC identifier associated with each device, or any other such identifier corresponding to the data processing devices. The received data, i.e., the license data, pre-set number data, identifier data, etc., is then stored on the portable data device 112 at step 610 for further operations in accordance with this example embodiment of the subject application, as explained in greater detail with respect to FIG. 7.

Turning now to FIG. 7, there is shown a flowchart 700 illustrating a method for electronic license distribution for pre-installed software in accordance with one embodiment of the subject application. The methodology depicted in FIG. 7 begins at step 702, whereupon software is installed on at least one data processing device, e.g., the document processing device 104. In accordance with this example embodiment of the subject application, the software requires an activation license in order to be used by the document processing device 104. Preferably, the installed software is stored on the associated data storage device 110. It will be appreciated by those skilled in the art that the software is capable of being installed by a manufacturer or distributor of the document processing device 104 prior to shipment of the device 104 to an end user/customer. A determination is then made at step 704 as to whether the software is installed with an activation license. When the controller 108 or other suitable component associated with the document processing device 104 determines that the resident software already has a license associated therewith, flow proceeds to step 706, whereupon the installed software is activated in accordance with the available license and made available on the document processing device 104.

Upon a determination at step 704 that no activation license is available, flow proceeds to step 708 with the software remaining inactive as the controller 108 or other suitable component associated with the document processing device 104 waits for a suitable activation license. A determination is then made at step 710 as to whether a portable data device 112 has been detected. When no portable data device 112 is detected, flow returns to waiting for activation license data at step 708. When the portable data device 112 is detected by the controller 108 or other suitable component associated with the document processing device 104, e.g., the portable data device 112 has been operatively connected, inserted, or otherwise interfaced with the document processing device, flow proceeds to step 712. At step 712, the portable data device 112 is accessed by the controller to determine whether any license data is present. It will be appreciated by those skilled in the art that the portable data device 112 is representative of any non-volatile data storage device known in the art including, for example and without limitation, universal serial bus drives; flash memory, e.g., xD, SD, Compact Flash, memory stick, smart media, or the like; optical disk; magnetic storage; or the like.

Upon a determination at step 714 that no activation license data is present on the portable data device 112, the software remains inactive, i.e., unavailable for use by the document processing device 104, and flow returns to step 708. Following a determination at step 714 that license data is present on the portable data device 112, flow proceeds to step 716, whereupon identifier data corresponding to the document processing device 104 is compared to identifier data present on the accessed portable data device 112. In accordance with one example embodiment of the subject application, the identifier data includes a serial number of the document processing device 104, and the portable data device 112 includes one or more serial numbers for software license activation, depending upon the pre-set number of activation licenses stored thereon. The serial number of the document processing device 104 is then compared to those on the portable data device 112 to determine, at step 718, whether the identifiers, e.g., the serial numbers, match.

Upon a determination at step 718 that the identifiers do not match, the document processing device 104 is denied the ability to activate the software at step 720, which therefore remains unavailable for use by the document processing device 104. A determination at step 718 that the identifiers do match, e.g., the serial number of the document processing device 104 matches one of the serial numbers on the portable data device 112, prompts an analysis at step 722 of a count value associated with the pre-set number of available licenses. The analysis is used by the controller 108 to determine, at step 724, whether any activation licenses remain available. That is, a determination is made, whether the pre-set number of activation licenses stored on the portable data device 112 has been exhausted. When no license is available, based upon the count value, flow proceeds to step 720, whereupon the document processing device 104 is denied the ability to access the resident software.

Upon a determination at step 724 that a license is available, as determined via the count value analysis, license data is communicated to the document processing device 104 from the portable data device 112 at step 726. At step 728, the previously installed software resident on the data storage device 110 is activated and made available for use by the document processing device 104. The count value stored on the portable data device 112 is then decremented at step 730 so as to reflect the use of the license by the document processing device 104. Thus, the skilled artisan will appreciate that the administrator, distributor, or the like is thereafter able to proceed to the next data processing device, having pre-installed software for activation in accordance with the example embodiment described above.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier, being any entity or device capable of carrying the computer program: for example, a storage medium such as ROM or RAM; optical recording media such as CD-ROM or magnetic recording media such as floppy discs; or any transmissible carrier such as an electrical or optical signal conveyed by electrical or optical cable or by radio or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for electronic license distribution for pre-installed software comprising:
a data processing device including a data storage and a processor;
means adapted for commencing data communication between the data processing device and an associated portable data device;
communication means adapted for communicating license data between the portable data device and the data processing device, which license data is representative of a software license associated with software resident in a data storage associated with the data processing device; and
activation means adapted for activating the resident software in accordance with communicated license data.

2. The system of claim 1 wherein the portable data device includes a portable data storage adapted for storing data representative of a pre-set number of activation licenses available for multiple copies of resident software disposed in a plurality of data processing devices; and
further comprising means adapted for decrementing a count value associated with the pre-set number of activation licenses upon operation of the activation means.

3. The system of claim 2 wherein the count value is stored in the portable data storage.

4. The system of claim 3 further comprising means adapted for suspending activation of resident software when the count value corresponds to a use of all activation licenses associated with the pre-set number.

5. The system of claim 4 further comprising means adapted for storing activation data in the portable data storage, which activation data includes data representative of an identifier corresponding to each of a plurality of data processing devices for which resident software has been activated by the portable data storage.

6. The system of claim 1 wherein the communication means includes means adapted for communicating the license data in encrypted form, wherein encryption of the license data corresponds to identification data associated with the portable data device.

7. A method for electronic license distribution for pre-installed software comprising the steps of:
commencing data communication between a data processing device and an associated portable data device;
communicating license data between the portable data device and the data processing device, which license data is representative of a software license associated with software resident in a data storage associated with the data processing device; and
activating the resident software in accordance with communicated license data.

8. The method of claim 7 further comprising the steps of:
storing data representative of a pre-set number of activation licenses available for multiple copies of resident software disposed in a plurality of data processing devices in a portable data storage associated with the portable data device; and
decrementing a count value associated with the pre-set number of activation licenses upon an activation of the resident software.

9. The method of claim 8 wherein the count value is stored in the portable data storage.

10. The method of claim 9 further comprising the step of suspending activation of resident software when the count value corresponds to a use of all activation licenses associated with the pre-set number.

11. The method of claim 10 further comprising the step of storing activation data in the portable data storage, which activation data includes data representative of an identifier corresponding to each of a plurality of data processing devices for which resident software has been activated by the portable data storage.

12. The method of claim 7 further comprising the step of communicating the license data in encrypted form, wherein encryption of the license data corresponds to identification data associated with the portable data device.

13. A computer-implemented method for electronic license distribution for pre-installed software comprising the steps of:
commencing data communication between a data processing device and an associated portable data device;
communicating license data between the portable data device and the data processing device, which license data is representative of a software license associated with software resident in a data storage associated with the data processing device; and
activating the resident software in accordance with communicated license data.

14. The computer-implemented method of claim 13 further comprising the steps of:
storing data representative of a pre-set number of activation licenses available for multiple copies of resident software disposed in a plurality of data processing devices in a portable data storage associated with the portable data device; and
decrementing a count value associated with the pre-set number of activation licenses upon an activation of the resident software.

15. The computer-implemented method of claim 14 wherein the count value is stored in the portable data storage.

16. The computer-implemented method of claim 15 further comprising the step of suspending activation of resident software when the count value corresponds to a use of all activation licenses associated with the pre-set number.

17. The computer-implemented method of claim 16 further comprising the step of storing activation data in the portable data storage, which activation data includes data representative of an identifier corresponding to each of a plurality of data processing devices for which resident software has been activated by the portable data storage.

18. The computer-implemented method of claim 13 further comprising the step of communicating the license data in encrypted form, wherein encryption of the license data corresponds to identification data associated with the portable data device.
